(19) United States
(12) Patent Application Publication
(10) Pub. No.: US 2010/0028047 A1
(43) Pub. Date: Feb. 4, 2010

(54) ELECTROPHOTOGRAPHIC PHOTORECEPTOR AND IMAGE FORMING APPARATUS

(76) Inventors: Akihiro Kondoh, Osaka (JP); Takatsugu Obata, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/533,243

(22) Filed: Jul. 31, 2009

(30) Foreign Application Priority Data
Aug. 1, 2008 (JP) 2008-199670

(51) Int. Cl. G03G 15/04; G03G 5/02; G03G 5/04

(52) U.S. Cl. 399/177; 430/56; 430/58.75; 430/58.15; 430/60

(57) ABSTRACT

The present invention provides an image forming apparatus provided with the highly sensitive electrophotographic photoreceptor comprising an enamine compound as a charge transport substance having a specific enamine structure; and provided with the semiconductor laser oscillating the laser beam with the oscillation wavelengths of from 390 nm to 500 nm inclusive in order to form an image having a high resolution for a long period of time.

### CROSS-REFERENCE TO RELATED APPLICATION

This application is related to Japanese Patent Application No. 2008199670 filed on 1 Aug., 2008, whose priority is claimed under 35 USC §119, and the disclosure of which is incorporated by reference in its entirety

### BACKGROUND OF THE INVENTION

1. Field of the Invention

The present invention relates to an electrophotographic apparatus. More particularly, it relates to an electrophotographic apparatus that may actualize a high resolution of an image formed by means of a laser as an exposing source which oscillates a short-wavelength laser.

2. Description of the Related Art

In recent years, electrophotographic photoreceptors have generally been using an organic photoconductive material, as development of the electrophotographic photoreceptors progresses, instead of an inorganic photoconductive material which has been conventionally used. A reason why the electrophotographic photoreceptors have generally been using the organic photoconductive material is that the organic photoconductive material has many advantages in points of toxicity, production cost, freedom of material designing, and the like in comparison with the inorganic photoconductive material, although it has slight problems concerning sensitivity, durability, stability to environments, and the like.

As a structure of the electrophotographic photoreceptor using the organic photoconductive material which is generally used at present, a functional separation-type photoreceptor is proposed, which has a laminated type and a dispersion type. Both the laminated and dispersion types allot a charge generation function and a charge transport function of photoconducting functions to separate materials respectively.

Such a functional separation-type photoreceptor can use the separate materials, of which each has a wide range of materials to be selected from, and also can offer high performance of electrophotographic properties such as a charging characteristic, sensitivity, a residual potential, a repetition property, printing-resistance, and the like by a combination of the most compatible materials.

The electrophotographic photoreceptor using the organic photoconductive material can be prepared by coating a conductive substrate with a photosensitive layer, and therefore productivity efficiency of the electrophotographic photoreceptor is remarkably high, and production cost thereof is low. Also, this electrophotographic photoreceptor can freely control its photosensitive wavelength area and luminous sensitivity.

Further, the electrophotographic photoreceptor using the organic photoconductive material can properly select a binder resin (which may also be called a binding resin) which is to be contained in a charge transport layer of the electrophotographic photoreceptor, so that the electrophotographic photoreceptor can be designed to have excellent wear resistance.

As a result of solving the problems of the conventional electrophotographic photoreceptors and achieving improvement of the performance of the electrophotographic photoreceptors using the organic photoconductive material, the organic photoconductive material has been used more than the inorganic photoconductive material.

Moreover, although a laser printer is a typical example of the electrophotographic apparatus in which the laser is the exposing source, a copy machine has been digitalized in recent years and thereby has commonly used a laser as an exposing source as well.

Among lasers used as an exposing source, a semiconductor laser has practically been used due to low cost, low energy consumption, lightweight, and compact size. Particularly, a semiconductor laser has commonly been used, having stability of an oscillation wavelength and an output, and a long lifetime due to the oscillation wavelength of around 800 nm in a near-infrared area.

A reason why such a semiconductor laser has commonly been used is that there was technical difficulty to practically use a laser which oscillates a short-wavelength laser. Therefore, as a charge generation substance used in the electrophotographic apparatus in which the semiconductor laser is the exposing source, an organic compound, particularly a phthalocyanine pigment, has been developed, the organic compound having sensitivity to light which is to be absorbed into a long-wavelength area. Hence, a laminated electrophotographic photoreceptor has been developed, that has a charge generation layer comprising the above-mentioned organic compound.

Further, heightening a resolution of an image has been studied in order to improve quality of the image outputted from the electrophotographic apparatus. As a means of achieving the high resolution, i.e. a high record density, of the image, an optical method is exemplified, which is to narrow a spot diameter of a laser beam and to increase the record density.

On this account, a focal length of a lens used for narrowing the spot diameter of the laser beam needs to be shortened. However, design difficulty in terms of an optical system arises, and additionally it is difficult to obtain clearness of a spot outline of the laser beam with the oscillation wavelength of around 800 nm in the near-infrared area even if the spot diameter of the laser beam is narrowed by controlling the optical system. A reason why the clearness of the spot outline is difficult to be obtained is that diffraction of the laser beam is limited, and it is an inevitable phenomenon.

A spot diameter of a laser beam, which is focused onto a peripheral surface of a photoreceptor, can generally be calculated from an oscillation wavelength of the laser beam and a lens numerical aperture, and is represented by the following formula:

D=1.22 λ/NA

wherein D represents the spot diameter, λ represents the oscillation wavelength of the laser beam, and NA represents the lens numerical aperture.

Incidentally, as was described above, the development of the laser, which oscillates the laser beam with the short wavelength, has fallen behind the development of the laser, which oscillates the laser beam with the long wavelength. In the early 1990s, however, a red light laser has been developed, which oscillates a laser beam with an oscillation wavelength of around 650 nm.

In 1995, successful development of a blue-purple light laser has been announced, which oscillates a laser beam with an oscillation wavelength of around 410 nm. The blue-purple light laser is now commercialized as a light source for a blue-ray disc.

Although such a blue light-type laser has obtained an excellent result of improving a record density of an optical disc, this laser was hardly counted on as an exposing source of electrophotographic apparatus.

A reason why the blue light-type laser was not counted on as the exposing source was that the conventional electrophotographic photoreceptors did not have sensitivity to the laser beam with the oscillation wavelength of around 410 nm.

The conventional, generally used laminated electrophotographic photoreceptor has a structure that a charge generation layer and a charge transport layer are laminated in this order on a conductive substrate. If this laminated electrophotographic photoreceptor would have contained a charge generation substance that absorbs a laser beam with a wavelength of 500 nm or less, it would have sensitivity to this laser beam with the short wavelength of 500 nm or less.

In reality, however, the charge transport layer, i.e. a charge transport substance contained therein, which is laminated on the charge generation layer has absorbed the laser beam with the wavelength of 500 nm or less. Therefore, the laser beam with the short wavelength emitted from the exposing source was absorbed into a surface of a photosensitive layer, and did not reach to the charge generation layer. Accordingly, the conventional laminated electrophotographic photoreceptor did not have the sensitivity to the laser beam with the wavelength of 500 nm or less.

The conventional laminated electrophotographic photoreceptor had further problems such that the charge transport substance and the charge generation substance were easily deteriorated due to the exposure to light having high energy with the short wavelength, the sensitivity of the electrophotographic photoreceptor decreased after the photoreceptor was used for a long term, and quality of an image formed by the electrophotographic photoreceptor decreased.

The present invention has an object of providing an electrophotographic photoreceptor having high sensitivity to a laser beam even in a wavelength area of from 390 nm to 500 nm inclusive and excellent durability to withstand deterioration caused by light.

The present invention has another object of providing an electrophotographic apparatus that stably forms an image by means of the above-mentioned electrophotographic photoreceptor and a semiconductor laser; the electrophotographic photoreceptor has the high sensitivity and a high resolving power, and the semiconductor laser oscillates a laser beam with oscillation wavelengths of from 390 nm to 500 nm inclusive.

### SUMMARY OF THE INVENTION

After carrying out patient and effortful research in order to solve the above-mentioned problems, the inventors of the present invention have found that an enamine compound having a specific substitution style does not absorb light with wavelengths of from 390 nm to 500 nm inclusive, but has charge mobility higher than that of the conventional charge transport substance. Accordingly, the inventors of the present invention have found that an electrophotographic photoreceptor having high sensitivity and resolving power and an electrophotographic apparatus can be provided by use of the enamine compound, which has the specific substitution style, as a charge transport substance.

Consequently, the present invention provides an electrophotographic photoreceptor that is exposed to a laser beam with oscillation wavelengths of from 390 nm to 500 nm inclusive oscillated from a semiconductor laser, and that is provided with a photosensitive layer formed on a conductive substrate, the photosensitive layer comprising an enamine compound represented by the general formula (1):

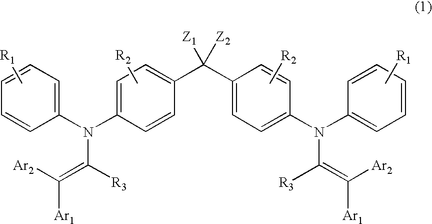

wherein Ar₁ and Ar₂ are independent from each other, and each represent an aryl or heterocyclic group which may have a substituent(s);
R₁ and R₂ are independent from each other, and each represent a hydrogen atom, a halogen atom or an alkyl or alkoxy group which may have a substituent(s);
R₃ represents a hydrogen atom or an alkyl group which may have a substituent(s); and
Z₁ and Z₂ are independent from each other, and each represent an alkyl group, or may be combined together with the carbon atom with which these groups are connected to form a ring structure.

The present invention also provides an image forming apparatus provided with the above-mentioned electrophotographic photoreceptor, and as an exposing source, a semiconductor laser emitting a laser beam with oscillation wavelength of from 350 nm to 500 nm inclusive from a gallium nitride-based material as a light source. This gallium nitride-based material can generate a high-power laser beam that is to be adapted to a high-speed image formation.

The present invention further provides an image forming apparatus provided with the above-mentioned electrophotographic photoreceptor; the image forming apparatus forms an image by a reversal development process.

Since the enamine compound of the present invention represented by the general formula (1) does not absorb the laser beam with the oscillation wavelengths of from 390 to 500 nm inclusive, and has four units of a conjugated system (e.g. an “S” parameter of the Sharp technique described in 76(8), 36(2000)) which is a hopping site of a hole, it has the charge mobility higher than triaryl amine derivatives that are typical examples of the charge transport substance which does not absorb the laser beam with the oscillation wavelengths of from 390 nm to 500 nm inclusive. Therefore, the electrophotographic photoreceptor of the present invention, which is exposed to the laser beam in the wavelength area of from 390 nm to 500 nm inclusive oscillated from the exposing source, comprises the enamine compound represented by the general formula (1), so that the electrophotographic photoreceptor having the high sensitivity and resolving power and the electrophotographic apparatus can be provided.

### BRIEF DESCRIPTION OF THE DRAWINGS

FIG. 1 is a typical cross-section view showing an essential structure of a photoreceptor of the present invention;

FIG. 2 is a typical cross-section view showing an essential structure of a photoreceptor of the present invention;

FIG. 3 is a typical cross-section view showing an essential structure of a photoreceptor of the present invention; and

FIG. 4 is a typical cross-section view showing a structure of an image forming apparatus of the present invention.

### DESCRIPTION OF THE PREFERRED EMBODIMENTS

An enamine compound of the present invention is represented by the following general formula (1):

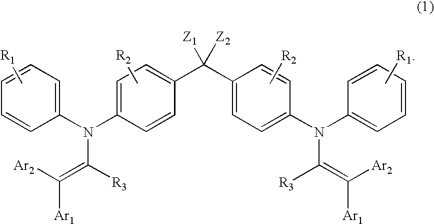

In the above-mentioned general formula (1), Ar₁ and Ar₂ are independent from each other, and each represent an aryl or heterocyclic group which may have a substituent(s).

Examples of the aryl group represented by Ar₁ and Ar₂ each include phenyl, tolyl, naphthyl, pyrenyl and biphenyl group, and the like.

Examples of the heterocyclic group represented by Ar₁ and Ar₂ each include a monovalent heterocyclic group such as furyl, thienyl, benzofuryl, benzothiophenyl and benzothliazolyl group, and the like.

The above-mentioned aryl and heterocyclic group each may optionally have one or more substituents. Examples of the substituents include an alkyl group having from 1 to 4 carbon atom(s) inclusive (which may be substituted with one or more halogen atom(s) or alkoxy group(s) each having from 1 to 4 carbon atom(s) inclusive), an alkoxy group having from 1 to 4 carbon atom(s) inclusive (which may be substituted with one or more halogen atom(s) or alkyl group(s) each having from 1 to 4 carbon atom(s) inclusive), a halogen atom (in which a fluorine atom is preferable), a phenoxy group, and a phenylthio group. However, the substituents are not limited to these examples.

Examples of the alkyl group include methyl, ethyl, n-propyl, isopropyl, n-butyl, sec-butyl or tert-butyl group.

Examples of the alkoxy group include methoxy, ethoxy, isopropoxy or tert-butoxy group.

R₁ and R₂ are independent from each other, and each represent a hydrogen atom, an alkyl group which may have a substituent(s), an alkoxy group which may have a substituent(s), or a halogen atom.

R₃ represents a hydrogen atom or an alkyl group which may have a substituent(s).

Examples of the alkyl group represented by R₁, R₂ and R₃ each, which may have the substituent(s), include methyl, ethyl, propyl, isopropyl and trifluoromethyl group, and the like.

Examples of the alkoxy group represented by R₁ and R₂ each, which may have the substituent(s), include methoxy, ethoxy and isopropoxy group, and the like.

Examples of the halogen atom represented by R₁ and R₂ each include a fluorine atom, a chlorine atom, and the like.

Z₁ and Z₂ are independent from each other, and each represent an alkyl group, or may be combined together with the carbon atom with which these groups are connected to form a ring structure.

Examples of the alkyl group represented by Z₁ and Z₂ each include methyl, ethyl, n-propyl, n-butyl, n-pentyl and n-hexyl group, and the like.

Examples of the ring structure that may be formed together with the carbon atom with which Z₁ and Z₂ are connected include cyclopentylene, cyclohexylene and cycloheptylene group, and the like.

The enamine compound of the present invention is represented by the following general formula (1):

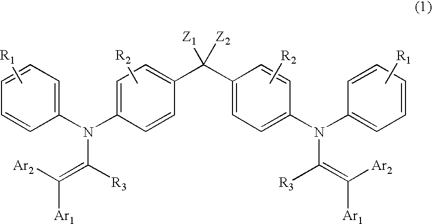

wherein Ar₁, Ar₂, R₁, R₂, R₃, Z₁ and Z₂ are the same as those defined above. Examples of the enamine compound are listed in Tables 1-1 to 1-4 below. However, the enamine compound is not limited to these examples.

TABLE 1-1

| Compound | Structure |
|---|---|
| Compound 1 | 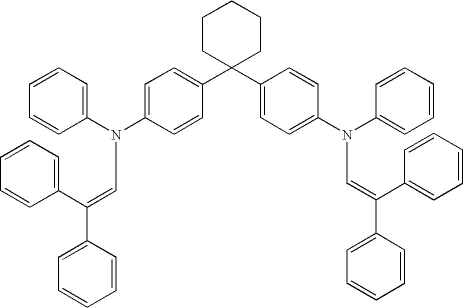 |
| Compound 2 | 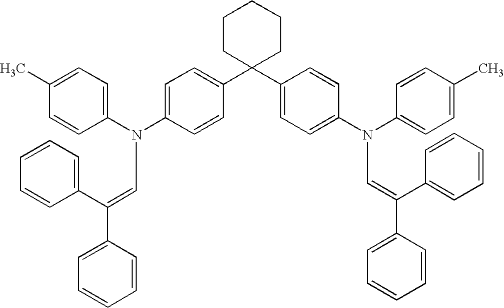 |
| Compound 3 | 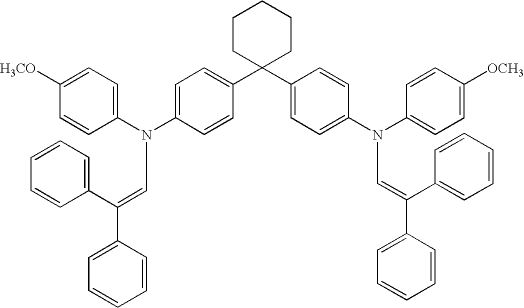 |

TABLE 1-2

| | |
|---|---|
| Compound 4 | 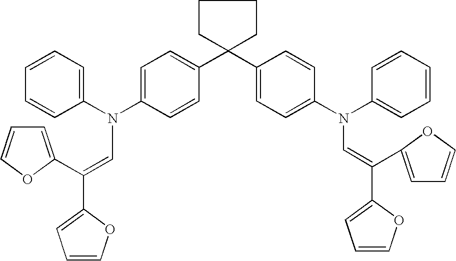 |
| Compound 5 | 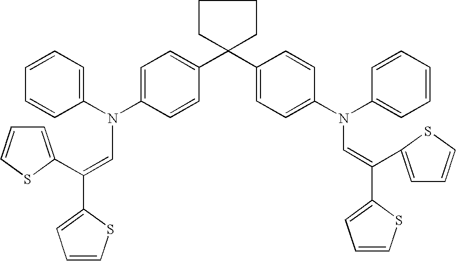 |
| Compound 6 | 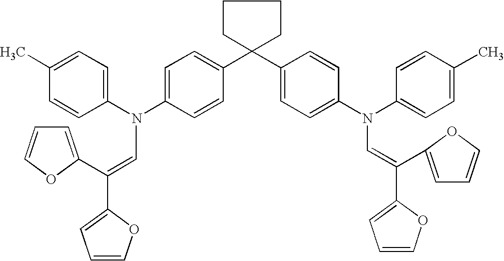 |
| Compound 7 | 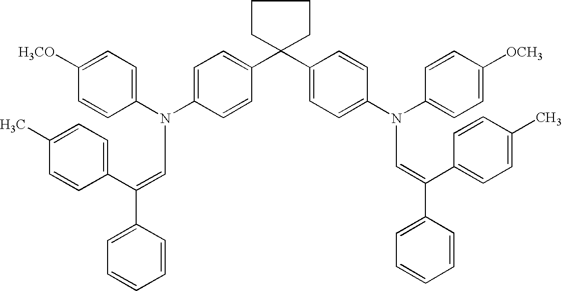 |
| Compound 8 | 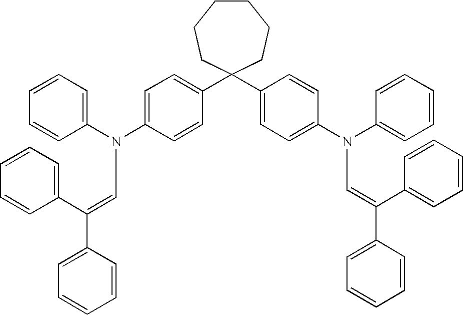 |
| Compound 9 | 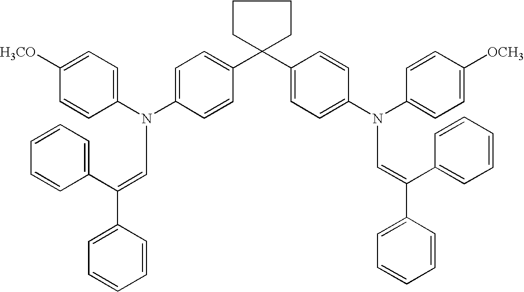 |

TABLE 1-3

| | |
|---|---|
| Compound 10 | 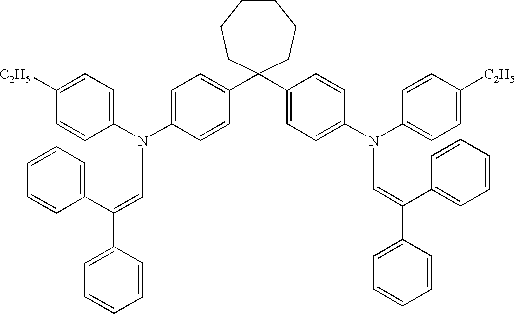 |
| Compound 11 | 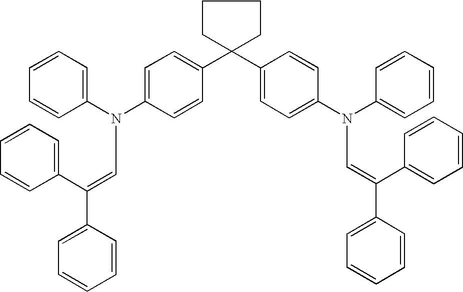 |
| Compound 12 | 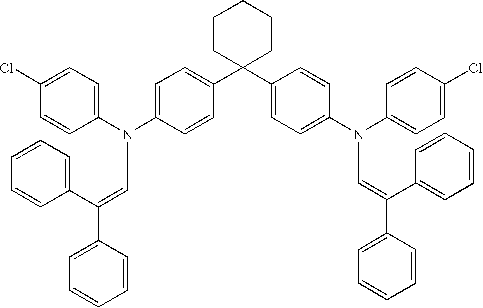 |
| Compound 13 | 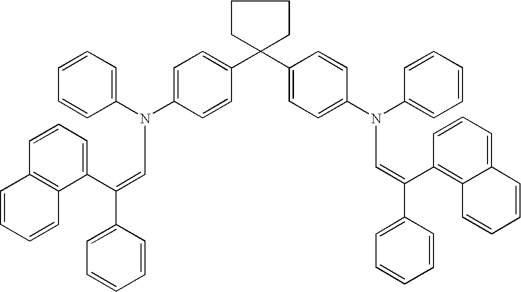 |
| Compound 14 | 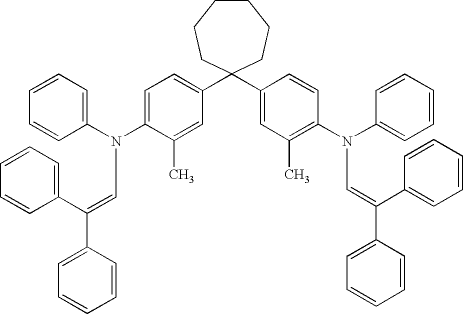 |
| Compound 15 | 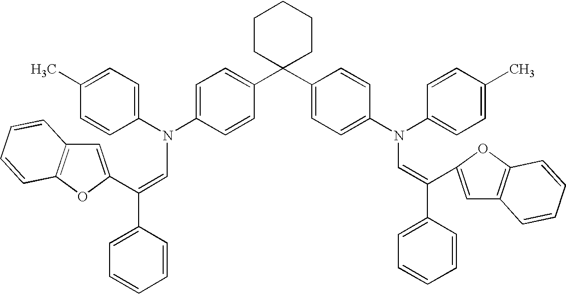 |

TABLE 1-4

| | |
|---|---|
| Compound 16 | 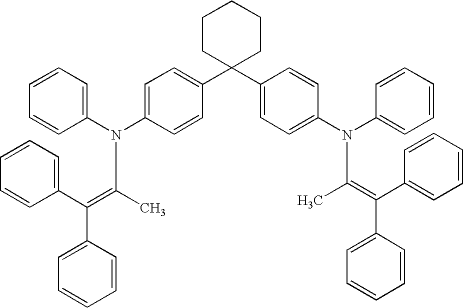 |
| Compound 17 | 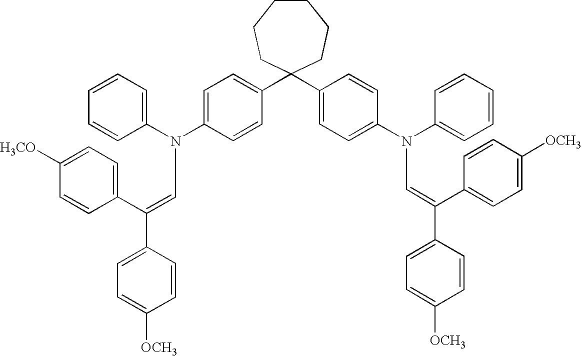 |
| Compound 18 | 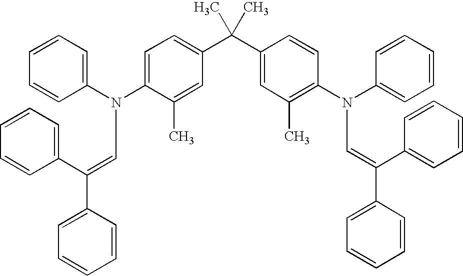 |
| Compound 19 | 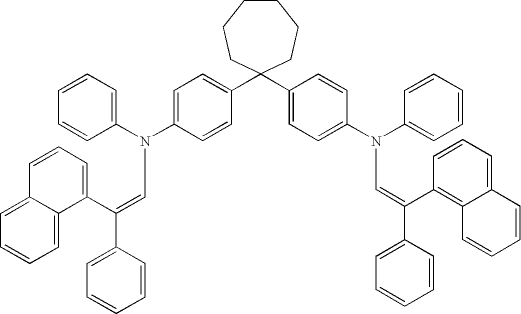 |
| Compound 20 | 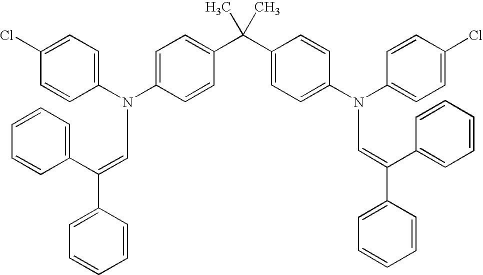 |
| Compound 21 | 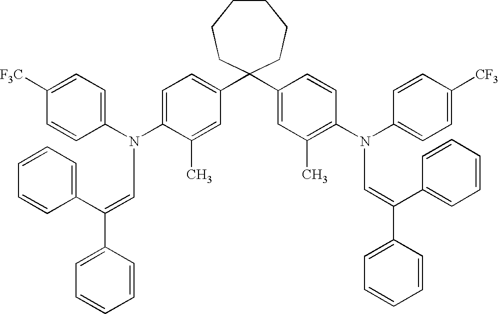 |

The enamine compound of the present invention represented by the above-mentioned general formula (1) can be prepared as follows.

For example, a secondary diamine compound represented by the following general formula (2):

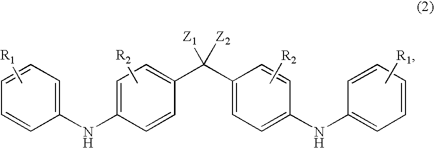

wherein R₁, R₂, Z₁ and Z₂ are the same as those of the general formula (1), and
a carbonyl compound represented by the following general formula (3):

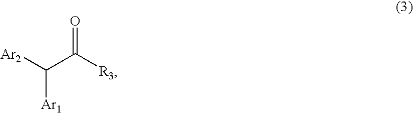

wherein R₃, Ar₁ and Ar₂ are the same as those of the general formula (1),
are conducted to a condensation reaction by dehydration in a solvent so as to prepare the enamine compound.

This condensation reaction dehydration is conducted, for example, when 1 mole of the secondary diamine compound represented by the general formula (2) and 2 moles of the carbonyl compound represented by the general formula (3) in the solvent are heated in the presence of a catalyst.

Examples of the solvent used in this reaction include: alcohols such as butanol and the like; ethers such as diethylene glycol dimethyl ether and the like; ketones such as methyl isobutyl ketone and the like; and nonpolar solvents such as toluene, xylene, chlorobenzene, and the like.

Examples of the catalyst used in this reaction include an acidic catalyst such as p-toluenesulfonic, camphorsulfonic and pyridinium-p-toluenesulfonic acids, and the like.

A ratio of the acidic catalyst to the secondary amine compound as a starting material ranges from 1/10 to 1/1,000 mole equivalent inclusive. However, a ratio ranging from 1/25 to 1/500 mole equivalent inclusive is preferable, and a ratio ranging from 1/50 to 1/200 mole equivalent inclusive is more preferable.

In the condensation reaction by dehydration, the secondary diamine compound and the carbonyl compound are heated at a boiling point or higher of the solvent, so that water will be eliminated, which is an accessory component and prevents the condensation reaction by dehydration from proceeding. Namely, since the water and the solvent cause azeotropy by being heated, and the water causes a condensation reaction due to use of a reactor provided with a Dean-Stark for eliminating the water, a high yield of the enamine compound represented by the general formula (1) can be prepared. To eliminate the water, a water absorbent, such as a molecular sieve and the like, may be added to a reaction system in order to cause the condensation reaction of the water.

The electrophotographic photoreceptor of the present invention is constituted of a conductive substrate comprising a photoconductive material, and a photosensitive layer, which is positioned on the conductive substrate, comprising at least a charge generation substance and a charge transport substance; the electrophotographic photoreceptor comprises the enamine compound of the present invention represented by the general formula (1) as the charge transport substance.

conductive Substrate

Examples of the conductive substrate include: metallic drum-like and sheet-like substrates which comprise aluminum, aluminum alloy, copper, zinc, stainless steel, titanium or the like; drum-like, sheet-like and seamless belt-like substrates in which a high-polymer material such as polyethylene terephthalate, nylon, polystyrene and the like, hard paper, and glass each are laminated with a metallic foil on its surface; drum-like, sheet-like and seamless belt-like substrates in which a high-polymer material such as polyethylene terephthalate, nylon, polystyrene and the like, hard paper, and glass each are subjected to a metal-evaporation treatment; and drum-like, sheet-like and seamless belt-like substrates in which a high-polymer material such as polyethylene terephthalate, nylon, polystyrene and the like, hard paper, and glass each are vapor-deposited or coated with a conductive compound such as a conductive polymer, tin oxide, indium oxide and the like.

In an electrophotographic process which uses the laser as the exposing source, it is known that a laser beam emitted from the laser and a laser beam reflected off the inside of the electrophotographic photoreceptor interfere with each other, and this interference could cause an image defect due to an interference pattern appeared on an image.

Therefore, a surface of the conductive substrate can be subjected to, as needed and within the bounds of not affecting image quality, an anodic oxide coating treatment; a surface treatment by use of a chemical, hot water or the like; a staining treatment; or a diffuse treatment which roughens the conductive substrate surface, so as to prevent the image defect caused by the interference of the laser beams whose wavelengths are uniform.

### Under-Coating Layer

The conductive substrate and the photosensitive layer can have an under-coating layer therebetween.

In the case where an image is formed by a reversal development process, surface charges of a part of a peripheral surface of the photoreceptor decrease, where is exposed to the laser beam, and therefore a toner image is formed on the exposed part of the peripheral surface of the photoreceptor. However, if surface charges decrease due to a reason other than the exposure to the laser beam, an image fogging is generated, which is a minute black spot (called a black dot) of a toner formed on a white background, and causes significant defect in image quality.

Namely, if electrification decreases in a minute region of the peripheral surface of the photoreceptor due to irregularities of the conductive substrate and/or the photosensitive layer, this decrease in electrification causes the image fogging, which is the minute black spot of the toner formed on the white background, to be generated, and also causes the significant defect of the image. To prevent the image fogging, the under-coating layer is provided between the conductive substrate and the photosensitive layer. The under-coating layer also has other purposes such that it covers the irregularities of the conductive substrate, improves the electrification of the photoreceptor, enhances adhesion of the photosensitive layer, and improves a coating property of the photosensitive layer.

Examples of materials of the under-coating layer include: various types of resin materials; and resin materials containing metal particles and/or metal oxide particles such as titanium oxide, aluminum oxide, aluminum hydride, tin oxide, and the like. Examples of the materials of the under-coating layer which is in the form of a single layer comprising a resin include: a resin material such as polyethylene, polypropylene, polystyrene, acryl resin, vinyl chloride resin, vinyl acetate resin, polyurethane resin, epoxy resin, polyester resin, melamine resin, silicone resin, polyvinyl butyral resin, polyamide resin, and the like; a copolymer resin which contains two or more repeat units of the examples of the above-mentioned resin material; casein; gelatin; polyvinyl alcohol; ethyl cellulose; and the like. Among these examples, the polyamide resin is preferable.

Among examples of the polyamide resin, an alcohol-soluble nylon resin is preferable. Among examples of the alcohol-soluble nylon resin, a copolymer nylon resin that copolymerizes 6-nylon, 6,6-nylon, 6,10-nylon, 11-nylon, 12-nylon, and the like; and a nylon resin that is chemically denatured such as N-alkoxymethyl denatured nylon and N-alkoxyethyl denatured nylon are preferable.

To adjust a volume resistance value of the under-coating layer, to prevent a carrier from being injected from the conductive substrate, and to maintain an electric property of the photoreceptor in various environments, the under-coating layer may contain the metal oxide particles such as titanium oxide. Such a coating solution for under-coating layer is formed by dissolving the resin in a solvent and dispersing the metal oxide particles such as titanium oxide in a mixture of the resin and the solvent. Examples of the solvent include: a sole solvent such as water and various organic solvents, especially water, methanol, ethanol, and butanol; a mixed solvent such as a mixture of water and alcohol and a mixture of two or more kinds of alcohols; a mixed solvent such as a mixture of acetone or dioxolan and alcohol; and a mixed solvent such as a mixture of alcohol and a chlorinated solvent such as dichloroethane, chloroform, trichloroethane, and the like.

This coating solution is applied to the conductive substrate, and consequently forms the under-coating layer.

Examples of a method for applying the coating solution of the under coating layer to the conductive substrate include a blade coating, a wirebar coating, a spray coating, an immersion coating, a bead coating, a curtain coating, and the like. In consideration of properties and productivity, a most suitable method can be selected from these examples of the application method. The immersion coating is to form an under-coating layer by immersing the conductive substrate in the coating solution fully contained in a solution bath, and then pulled up the conductive substrate from the coating solution with constant speed or gradually changing speed. The immersion coating is relatively easy and excellent in productivity and cost of the photoreceptor. Therefore, the immersion coating is widely used for preparing electrophotographic photoreceptors. Incidentally, the immersion coating may use a coating solution dispersing device (which is typified by an ultrasonic generator) in order to stabilize dispersibility of the coating solution.

A thickness of the under-coating layer ranges from 0.01 μm to 20 μm inclusive, but a thickness ranging from 0.05 μm to 10 μm inclusive is preferable.

In the case where the thickness of the under-coating layer falls below 0.01 μm, the under-coating layer does not substantially function properly, and does not cover the irregularities of the conductive substrate uniformly. Therefore, the under-coating layer cannot prevent the carrier from being injected from the conductive substrate, and the electrification of the photoreceptor decreases.

The under-coating layer with the thickness of 20 μm or more is difficult to be formed in the process of immersing the conductive substrate in the coating solution and preparing the photoreceptor, and is not preferable since sensitivity of the photoreceptor decreases.

As a dispersing method into a coating solution for under-coating layer, a general method can be used by means of a ball mill, a sand mill, an attritor, a vibrating mill, an ultrasonic dispersion device, or the like.

As a ratio of an amount of the resin and the metal oxide contained in the coating solution of the under-coating layer to an amount of the organic solvent used for the coating solution, a range from 3%/97% by weight to 20%/80% by weight inclusive is preferable.

### Charge Generating Layer

Examples of the effective charge generation substance used for the charge generation layer include: an azo-based pigment such as monoazo-based, bisazo-based, trisazo-based pigments, and the like; an indigo-based pigment such as indigo, thioindigo, and the like; a perylene-based pigment such as perylene imido, perylene acid anhydride, and the like; a polycyclic quinone-based pigment such as anthraquinone, pyrenequinone, and the like; a phthalocyanine-based pigment such as metallophthalocyanine, non-metallophthalocyanine, and the like; and an inorganic material such as squarylium dye, pyrylium salts, thiopyrylium salts, triphenylmethane-based dye, selenium, amorphous silicon, and the like.

These examples of the charge generation substance can be used solely, or the two or more examples can be mixed. Further, these examples may be mixed with one or more following dyes: a triphenylmethane-based dye such as Methyl Violet, Crystal Violet, Night Blue, Victoria Blue, and the like; an acridine dye such as Erythrocine, Rhodamine B, Rhodamine 3R, Acridine Orange, flapeocine, and the like; a thiazine dye such as Methylene Blue, Methylene Green, and the like; an oxazine dye such as Capri Blue, Meldola's Blue, and the like; a sensitizing dye such as cyanine dye, styrene dye, pyrylium salt dye, thiopyrylium salt dye, and the like.

Examples of a method for forming the charge generation layer include: a method by vacuum-depositing the charge generation substance; and a method by mixing and dispersing the binder resin and the organic solvent. Generally, the latter method is preferable. Namely, the binder resin is dispersed in the organic solvent by a known technique, and a binder resin solution is applied to the conductive substrate. The binder resin may be subjected to a grinding treatment by use of a grinder mill, before the binder resin is dispersed in the organic solvent.

Examples of the grinder mill include a ball mill, a sand mill, an attritor, a vibrating mill, an ultrasonic dispersion device, and the like.

When the dispersion of the binder resin and the organic solvent is performed, it is preferred that an adequate dispersion condition is selected so that an impurity will be prevented from being mixed with the binder resin solution, the impurity being generated by friction of a container and/or a dispersion media used for the dispersion.

Examples of a method for applying the coating solution of the charge generation layer include a spray coating, a bar coating, a roll coating, a blade coating, a ring coating, an immersion coating, and the like.

The immersion coating is to form an charge generation layer, after the under-coating layer is formed, by immersing the conductive substrate in the binder resin solution fully contained in a solution bath, and then pulling up the conductive substrate from the binder resin solution with constant speed or gradually changing speed. The immersion coating is relatively easy and excellent in productivity and cost of the photoreceptor. Therefore, the immersion coating is widely used for preparing electrophotographic photoreceptors.

A thickness of the charge generation layer ranges from 0.05 mm to 5 mm inclusive, but a thickness ranging from 0.1 mm to 1 mm inclusive is preferable.

### Binder Resin Used for the Charge Generation Layer

Examples of the binder resin used for the charge generation layer include polyester, polystyrene, polyurethane, phenol, alkyd, melamine, epoxy, silicone, acryl, methacryl, polycarbonate, polyalylate, polyalylate, phenoxy, polyvinyl butyral and polyvinyl formal resins and the like, and a copolymer resin, which contains two or more repeat units of the examples of the above-mentioned binder resin, such as an insulating resin like vinyl chloride-vinyl acetate, vinyl chloride-vinyl acetate-maleic acid anhydride and acrylonitrile-styrene copolymer resins and the like. However, the binder resin is not limited to the above-mentioned examples. Therefore, all resins that are commonly used can be used solely, or the two or more common resins can be mixed.

Examples of the solvent in which the above mentioned resin(s) is/are dissolved include: halogenated hydrocarbon such as methylene chloride, bichloride ethane, and the like; ketone such as acetone, methyl ethyl ketone, cyclohexanone, and the like; ester such as ethyl acetate, butyl acetate, and the like; ether such as tetrahydrofuran, dioxane, and the like; cellosolve such as dimethoxyethane and the like; aromatic hydrocarbon such as benzene, toluene, xylene, and the like; aprotic polar solvent such as N,N-dimethylformamide, N,N-dimethylacetoamide, and the like; and a mixed solvent of the two or more examples above.

As a compounding ratio between the charge generation substance and the binder resin, a range from 10% by weight to 99% by weight inclusive is preferable.

In the case where the compounding ratio between the charge generation substance and the binder resin falls below 10% by weight, the charge generation layer decreases its sensitivity. In the case where the compounding ratio between the charge generation substance and the binder resin exceeds 99% by weight, the charge generation layer does not only decrease its film strength but also decreases its dispersibility. Consequently, the number of large particles increases, and it becomes causes of the increased number of image defects and black spots.

### Charge Transport Layer

The charge transport layer comprises the enamine compound represented by the general formula (1), and one or more kinds of binder resins mixed with the enamine compound.

Depending on circumstances, the following materials may be mixed as charge transport substances: carbazole, oxazole, oxadiazole, thiazole, thiadiazole, triazole, imidazole, imidazolone, imidazolidine, bisimidazolidine, indole, pyrazolone, oxazolone, benzimdazole, quinazoline, benzofuran, acridine, phenazine, aminostyrene, triarylamine, triarylmethane, phenylenediamine, stilbene and benzidine derivatives; styryl, hydrazone and polycyclic aromatic compounds; a polymer (such as poly-N-vinylcarbazole, poly-1-vinyl pyrene, poly-9-vinyl anthracene, and the like) having a main chain or a side chain of a group including the above-mentioned charge transport substances; polysilane; and the like.

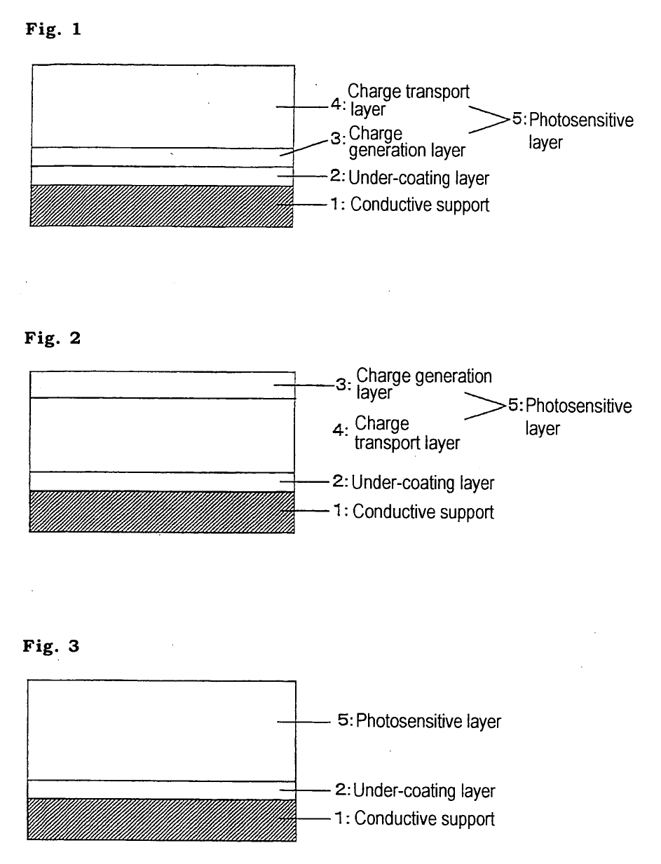

In the case where the photoreceptor is a functional separation type as shown in FIG. 1 in which a charge transport layer is formed on a charge generation layer, it is important that the charge transport layer is transparent, which is exposed to the laser beam emitted from the semiconductor laser. Therefore, as the charge transport substance, an arylamine-based or benzidine-based compound, which does not absorb a laser beam into a short-wavelength area, is preferable, but the enamine compound represented by the general formula (1) is optimal due to its high charge mobility.

The reversal development process has the problem that the image fogging, such as the black dot of the toner formed on the white background, is generated when an electric potential decreases, and thereby causes the significant defect in image quality. In the case where the photoreceptor is exposed to light having high energy with a short wavelength, in particular, the charge transport substance is deteriorated, and resistance of the charge transport substance decreases. Consequently, the charge transport substance cannot maintain electrical charges, and the above-mentioned problem becomes significant. On the other hand, the charge transport substance of the present invention has a stable chemical structure(s) and does not absorb the light with the short wavelength, and therefore it has a merit that such problems do not arise.

Binder Resin used for the Charge Transport Layer

The binder resin, which is to be contained in the charge transport layer, is desirable to have compatibility with the charge transport substance. Examples of the binder resin used for the charge transport layer include: a vinyl polymer such as polymethyl methacrylate, polystyrene, polyvinyl chloride, and the like; copolymers of the above-mentioned polymers; polycarbonate, polyester, polyester carbonate, polysulfone, phenoxy, epoxy, silicone, polyalylate, polyamide, polyketone, polyurethane, polyacrylamide and phenol resins; and the like. These examples of the binder resin may be used solely, or the two or more examples can be mixed. Also, a heat-hardening resin that is partially cross-linked may be used as the binder resin for the charge transport layer.

Among these examples, the polystyrene, polycarbonate, polyalylate and polyphenylene oxide resins and the like are preferable due to their volume resistance value of 10¹³Ω cm or more, excellent film formation and potential characteristic.

Further, a known plasticizer, such as diacid base ester-based, fatty acid ester-based, phosphoric ester-based, phthalate ester-based, chlorinated paraffin-based and epoxy-based plasticizers and/or a silicone-based leveling agent may be added to the binder resin as needed, so that processability and elasticity can be given to the photoreceptor and/or smoothness of the peripheral surface of the photoreceptor can be improved. Furthermore, minute particles of inorganic and organic compounds may be added to the binder resin, so that mechanical strength of the photoreceptor can increase and/or an electric property of the photoreceptor can be improved.

Generally, a weight ratio of an enamine compound to a binder resin is 1:1. However, since the enamine compound of the present invention has the high mobility, a content of the binder resin can be increased while the sensitivity of the photoreceptor is maintained. Therefore, a weight ratio between the enamine compound of the present invention and the binder resin can range from 10/12 to 10/25 inclusive.

Accordingly, due to increasing the content of the binder resin, printing-resistance of the charge transport layer can improve, and durability of the electrophotographic photoreceptor of the present invention can increase. Incidentally, the weight ratio of the binder resin over 10/25 is not preferable, since the photoreceptor cannot have the sufficient sensitivity.

Further, the charge transport layer may comprise an additives, such as an antioxidant, a sensitizer, and the like, in a mixture of the binder resin and the enamine compound as needed.

As the antioxidant, α-tocopherol and 2,6-di-t-butyl-4-methyl-phenol arc optimal. As a ratio of α-tocopherol to the charge transport substance, a range of from 0.1% by weight to 5% by weight inclusive is preferred. As a ratio of 2,6-di-t-butyl-4-methyl-phcnol to the charge transport substance, a range of from 0.1% by weight to 50% by weight inclusive is preferred. Due to the above-mentioned ratios, the potential characteristic of the photoreceptor improves, and stability of the mixture increases as the coating solution.

A thickness of the charge transport layer ranges from 10 μm to 60 μm inclusive, but a thickness ranging from 10 μm to 40 μm inclusive is preferable.

In the case where the thickness of the charge transport layer falls below 10 μm, the high electric potential cannot be maintained.

In the case where the thickness of the charge transport layer exceeds 60 μm, electrical charges laterally disperse while moving in the charge transport layer. Therefore, a resolution of an image decreases, and high image resolution, which is the feature of the present invention, cannot be actualized.

Examples of a method for forming such a charge transport layer are the same as those of the application methods of the under-coating layer and the charge generation layer, such as the immersion coating, the spray coating, a spinner coating, a roller coating, the wire-bar coating, the blade coating, and the like, with use of an applicable organic solvent(s).

Examples of the solvent for coating solution include: aromatic hydrocarbon such as benzene, toluene, xylene, monochlorobenzene, and the like; halogenated hydrocarbon such as dichloromethane, dichloroethane, and the like; and a solvent such as tetrachydrofuran, dioxane, dimethoxymethylether, dimethylformamide, and the like. The examples of the solvent can be used solely, or the two or more examples being mixed. Also, a solvent, such as alcohol, acetonitrile, methyl ethyl ketone, and the like, can further be added to the mixture of the binder resin and the enamine compound.

The photosensitive layer of the electrophotographic photoreceptor may contain one or more kinds of electron-accepting materials and/or pigments for the purpose of improving the sensitivity and suppressing a residual potential to increase and deterioration of the photoreceptor after being used repeatedly.

The electron-accepting materials include, for example, acid anhydrides such as succinic anhydride, maleic anhydride, phthalic anhydride, 4-chloronaphthalic anhydride, and the like; cyano compounds such as tetracyanoethylene, terephthalmalon dinitrile, and the like; aldehydes such as 4-nitrobenzaldehyde and the like; anthraquinones such as anthraquinone, 1-nitroanthraquinone, and the like; polycyclic or heterocyclic nitro compounds such as 2,4,7-trinitrofluorenone, 2,4,5,7-tetranitrofluorenone, and the like; and these electron-absorbing materials that are polymerized.

The pigments include, for example, organic photoconductive compounds such as xanthene-based pigment, thiazine-based pigment, triphenylmethane pigment, quinoline-based pigment, copper phthalocyanine, and the like. These pigments can be used as an optical sensitizer.

Moreover, due to providing a protective layer on a surface of the photosensitive layer, the photosensitive layer is protected from wear and/or adverse affects caused by ozone, nitroxide, and the like.

To reduce the deterioration of the peripheral surface of the electrophotographic photoreceptor caused by the repeated use or to improve the durability of the photoreceptor, each layer constituting the photosensitive layer may contain an adequate amount of a well-known antioxidant, such as phenol-based, hydroquinone-based, tocopherol-based and amine-based compounds and/or an ultraviolet absorber as needed.

A typical structure of the electrophotographic photoreceptor of the present invention is shown in FIGS. 1 to 3 each.

FIG. 1 shows a structure of a laminated functional separation-type photoreceptor, in which an under-coating layer (2), a charge generation layer (3), and a charge transport layer (4) are laminated in this order on a conductive substrate (1); the charge generation layer (3) and the charge transport layer (4) constitute a photosensitive layer (5). The charge generation layer (3) comprises at least a charge generation substance as a main component that is dispersed in a binder. The charge transport layer (4) comprises at least a charge transport substance as a main component that is dispersed in a binder. As the charge transport substance, the enamine compound of the present invention is used in the charge transport layer (4).

FIG. 2 shows a structure of a laminated functional separation-type photoreceptor, in which an under-coating layer (2), a charge transport layer (4), and a charge generation layer (3) are laminated in this order on a conductive substrate (1); the charge transport layer (4) and the charge generation layer (3) constitute a photosensitive layer (5). The charge transport layer (4) and the charge generation layer (3) shown in FIG. 2 are the same as those shown in FIG. 1, but the lamination order of these layers is opposite to that shown in FIG. 1. As the charge transport substance, the enamine compound of the present invention is used in the charge transport layer (4).

FIG. 3 shows a structure of a single-layer type photoreceptor, in which an under-coating layer (2) and a photosensitive layer (5) are laminated in this order on a conductive layer (1). The photosensitive layer (5) comprises a charge generation substance and a charge transport substance that are dispersed in a binder.

The image forming apparatus of the present invention is provided with: the photoreceptor of the present invention; charging means for charging the photoreceptor; exposure means for exposing the charged photoreceptor to light; and image development means for developing an electrical latent image formed by the exposure.

The image forming apparatus of the present invention will be described with reference to the drawings, but is not limited to the descriptions below.

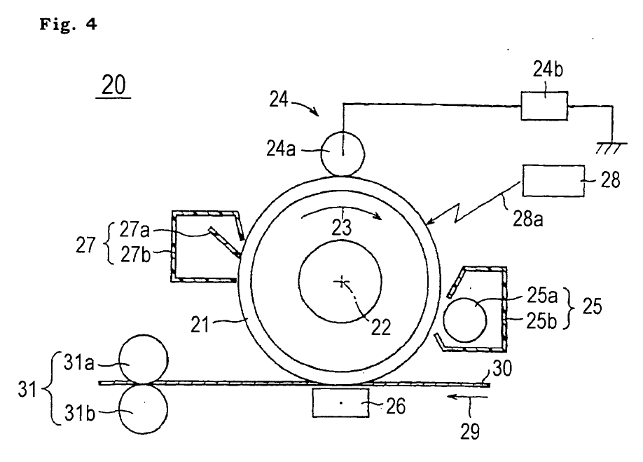

FIG. 4 is a typical cross-section view showing a structure of the image forming apparatus of the present invention.

An image forming apparatus 20 shown in FIG. 4 is constituted of: a photoreceptor 21 of the present invention (e.g. any one of the photoreceptors shown in FIGS. 1 to 3); charging means 24 (i.e. electrostatic charger); exposure means 28; image development means 25 (i.e. developing machine); a transferring machine 26; a cleaner 27; and a fixing machine 31. The reference numeral 30 denotes transfer paper as a recording medium.

The photoreceptor 21 is rotatably supported by an electrophotographic apparatus 20 body (not shown), and rotates in a direction of an arrow 23 on a rotation axis 22 by use of driving means (not shown).

The driving means is constituted of, for example, an electric motor and a decelerating gear, and conducts a driving force to the conductive substrate constituting a core body of the photoreceptor 21, so that the driving means rotates the photoreceptor 21 at a predetermined peripheral velocity.

The electrostatic charger 24, the exposure means 28, the developing machine 25, the transferring machine 26, and the cleaner 27 are positioned along a peripheral surface of the photoreceptor 21 in this order from upstream to downstream of the rotation direction of the photoreceptor 21 indicated by the arrow 23.

The electrostatic charger 24 is the charging means for charging the peripheral surface of the photoreceptor 21 at a predetermined potential. In the embodiments of the present invention, the electrostatic charger 24 uses a charger wire such as a corotron, a scorotron, and the like. As the charging means, a contact-type charging roller can also be used.

The exposure means 28 is provided with, for example, a semiconductor laser or the like as a light source; irradiates the peripheral surface of the photoreceptor 21 between the electrostatic charger 24 and the developing machine 25 with light 28a, such as a laser beam or the like, outputted from the light source; and exposes the charged peripheral surface of the photoreceptor 21 to the light 28a in accordance with image information. The light 28a repeatedly scans the peripheral surface of the photoreceptor 21 in an extending direction of the rotation axis 22 of the photoreceptor 21 which is a main scanning direction, and the repeated scanning form electrical latent images in series on the peripheral surface of the photoreceptor 21.

The developing machine 25 is the image development means for developing, with use of a developer, the electrical latent image formed on the peripheral surface of the photoreceptor 21 by the exposure; is positioned adjacent to the peripheral surface of the photoreceptor 21; and is constituted of a developing roller 25a for supplying a toner to the peripheral surface of the photoreceptor 21, and a casing 25b allowing the developing roller 25a to rotate on a rotation axis parallel to the rotation axis 22 of the photoreceptor 21 and storing the toner therein.

The transferring machine 26 is transfer means for transferring a toner image, which is a visible image formed on the peripheral surface of the photoreceptor 21 due to the image development, onto the transfer paper 30 which is supplied to a space between the photoreceptor 21 and the transferring machine 26 by conveying means (not shown) in a direction of an arrow 29. The transferring machine 26 is, for example, charging means, and may be noncontact transfer means supplying an electrical charge, which has a polarity opposite to that of the toner, to the transfer paper 30, so that a toner image is transferred onto the transfer paper 30.

The cleaner 27 is cleaning means for cleaning and collecting a toner remained on the peripheral surface of the photoreceptor 21 after the transfer of the toner image conducted by the transferring machine 26; and is constituted of a cleaning blade 27a for exfoliating the remaining toner on the peripheral surface of the photoreceptor 21, and a casing 27b for storing the toner therein exfoliated by the cleaning blade 27a. Incidentally, the cleaner 27 is provided with a static elimination lamp (not shown).

Further, the image forming apparatus 20 is provided with the fixing machine 31, which is fixing means for fixing the transferred image, downstream of the conveyance direction of the transfer paper 30. The transfer paper 30 is conveyed to the fixing machine 31 after passing through the space between the photoreceptor 21 and the transferring machine 26. The fixing machine 31 is constituted of a heating roller 31a provided with heating means (not shown), and a pressure roller 31b positioned opposite to the heating roller 31a and has a contact portion where is in contact with and pressed by the heating roller 31a.

An image formation by use of the image forming apparatus 20 is conducted as follows.

Firstly, the driving means rotates the photoreceptor 21 in the direction of the arrow 23, and then the electrostatic charger 24, which is positioned upstream of the rotation direction of the photoreceptor 21 from an image formation point of the light 28a emitted from the exposure means 28, positively or negatively charges the peripheral surface of the photoreceptor 21 uniformly at the predetermined potential.

Secondly, the exposure means 28 irradiates the peripheral surface of the photoreceptor 21 with the light 28a in accordance with image information.

Due to this exposure, an electrical charge on a partial peripheral surface of the photoreceptor 21 where is irradiated with the light 28a is eliminated. Therefore, it results in a difference between a potential on the partial peripheral surface where is irradiated with the light 28a and a potential on the other peripheral surface where is not irradiated with the light 28a, and thus an electrical latent image is formed on the peripheral surface of the photoreceptor 21. Incidentally, as the exposure means 28, the semiconductor laser is generally used. However, in the present invention, a short-wavelength laser is used, with oscillation wavelengths of from 390 nm to 500 nm inclusive.

Thirdly, the developing machine 25, which is positioned downstream of the rotation direction of the photoreceptor 21 from the image formation point of the light 28a emitted from the exposure means 28, supplies a toner to the peripheral surface of the photoreceptor 21 on which the electrical latent image is formed; and develops the electrical latent image, so that a toner image is formed on the peripheral surface of the photoreceptor 21.

Lastly, transfer paper 30 is supplied to the space between the photoreceptor 21 and the transferring machine 26 simultaneously with the exposure of the photoreceptor 21 to the light 28a. The transfer paper 30 is supplied with an electrical charge, which has a polarity opposite to that of the toner, by the transferring machine 26, and then the toner image formed on the peripheral surface of the photoreceptor 21 is transferred onto the transfer paper 30.

The transfer paper 30, onto which the toner image is transferred, is conveyed by the conveying means to the fixing machine 31; and is heated and pressed while passing through the contact portion between the heating roller 31a and the pressure roller 31b of the fixing machine 31. Then, the toner image is fixed to the transfer paper 30, and becomes a durable image. The transfer paper 30 on which the durable image is formed in this way is then ejected from the image forming apparatus 20 by the conveying means.

Meanwhile, the toner, which is remained on the peripheral surface of the photoreceptor 21 after the transfer of the toner image conducted by the transferring machine 26, is exfoliated from the peripheral surface by the cleaner 27; and is collected. The electrical charge on the peripheral surface of the photoreceptor 21, from which the toner is eliminated in this way, is eliminated by light emitted from the static elimination lamp, and the electrical latent image formed on the peripheral surface of the photoreceptor 21 disappears. Then, the driving means rotates the photoreceptor 21 again, and the above-mentioned sequence starts from the charging of the peripheral surface of the photoreceptor 21, so that images are formed successively.

The image forming apparatus 20 of the present invention uses the enamine compound of the present invention in the charge transport layer, so that the laser emitting the laser beam in a wavelength area of from 390 nm to 500 nm inclusive can be used as the exposing source, and the image with the high resolution can be formed.

### EXAMPLES

The present invention will be described in detail by means of Preparation Examples of Compounds 1 to 21 (see Tables 1-1 to 1-4), Examples, and Comparative Examples. However, the present invention is not limited to these Preparation Examples and Examples.

It is to be noted that a chemical structure, a molecular weight, and an elemental analysis of a compound prepared by Preparation Examples each were measured by use of the below-mentioned device(s) under the below-mentioned condition(s).

### Chemical Structure

### Nuclear Magnetic Resonance Apparatus (NMR)

Model name: DPX-200; manufactured by Bruker Biospin K.K.

### Sample Adjustment

Approximately 4 mg of a sample/0.4 m of CDCl₃
Measurement mode: ¹H (normal), ¹³C (normal, DPET 135)
   Note: In the NMR measurement, a word “s” indicates a singlet, and a word “br” indicates a broad peak width.

### Molecular Weight

### Molecular Weight Measurement Apparatus

LC-MS (Model name: Finnigan LCQ Deca (mass spectrometer system); manufactured by Thermoquest Corp.)

### LC Column

Model name: Inertsil ODS-3 (2.1×100 mm);
manufactured by GI-Sciences

### Column Temperature

40° C.
   Eluent p1 methanol: water=90: 10

### Injection Volume of a Sample

5 μm

### Detector

UV 254 nm and MS ESI

### Elemental Analysis

### Elemental Analysis Apparatus

Model name: Elemental Analysis 2400; manufactured by Perkin Elmer, Inc.

### Sample Amount

Approximately 2 mg that is precisely measured Gas Flow Rate (ml/min)
He: 1.5, O₂: 1.1, N₂: 4.3

### Temperature Setting of Combustion Tube

925° C.

### Temperature Setting of Reduction Tube

640° C.
   Note: The elemental analysis was conducted by means of a simultaneous quantitation method for analyzing carbon (C), hydrogen (H), and nitrogen (N) with use of a differential thermal conductivity method.

A preparation example of Compound 1 will be described, but is not limited to the descriptions below.

### Preparation Example 1

### Preparation of Compound 1

1.7 g (1.0 equivalent) of a diamine compound represented by the following structural formula (4):

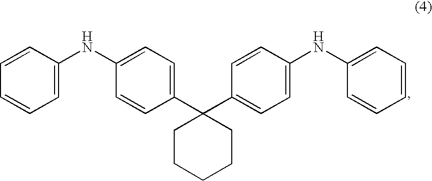

2.1 g (2.01 equivalent) of diphenylacetoaldehyde represented by the following structural formula (5):

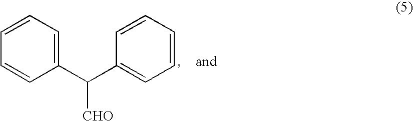

0.023 g (0.01 equivalent) of DL-10-camphorsulfonic acid were added to 50 mL of toluene contained in a reactor vessel provided with a Dean-Stark. A mixture was heated while being refluxed so that the toluene and water, which cause azeotropy, are eliminated, and was allowed to react for six hours. After the reaction, the reacted mixture was condensed to approximately one tenth ( 1/10) in volume, and was gradually dropped into 100 mL of hexane while the reacted mixture was vigorously stirred. A crystal formed in a mixture was filtered and washed with cold ethanol. Then, the washed crystal was recrystallized with use of a mixed solvent of ethanol and ethyl acetate, and 3.47 g (88% of yield) of a white powdered compound was obtained.

The white powdered compound was analyzed by use of the LC-MS, and a peak of 775.8 was observed, which corresponds to a molecular ion of [M+H]⁺ in which a proton affixes to Compound 1 (theoretical value of molecular weight: 774.40) with a mass spectrum of a main peak.

The white powdered compound was also analyzed by use of NIMR, and ¹H-NMR spectra (normal) indicated that δ(ppm)=1.3 (br s, 8H), 2.1 (br s, 4H), 6.8 (s, 2H), and 7.0 to 7.4 (m, 30H).

Further, Compound 1 obtained in such a manner was found to have a purity of 99.3% from the analytical result of LC-MS.

The elemental analysis of Compound 1 was conducted by means of the simultaneous quantitation method for analyzing carbon (C), hydrogen (H), and nitrogen (N) with use of the differential thermal conductivity method.

The below-mentioned Preparation Examples were conducted in the same manner as Preparation Example 1.

### Elemental Analysis Values

Theoretical Values:
C: 89.88%
H: 6.05%
N: 3.61%

Actual Measurement Values:
C: 89.62%
H: 5.84%
N: 3.47%

As the results of the above-mentioned analyses, the obtained crystal was confirmed as Compound 1.

Furthermore, according to UV absorption spectra, Compound 1 obtained by this preparation was found to have a maximum absorption wavelength of 320 nm and an absorption end of 385 nm.

### Preparation Examples 2 to 4

### Preparations of Compounds 2, 9 and 16

Compounds 2, 9 and 16 were prepared in the same manner as Compound 1, but material compounds shown in Table 2 below were used as amine and carbonyl compounds.

It is to be noted that material compounds of Compound 1 are also shown in Table 2.

Further, analysis values obtained in Preparation Examples 1 to 4 are also shown in Table 2.

TABLE 2

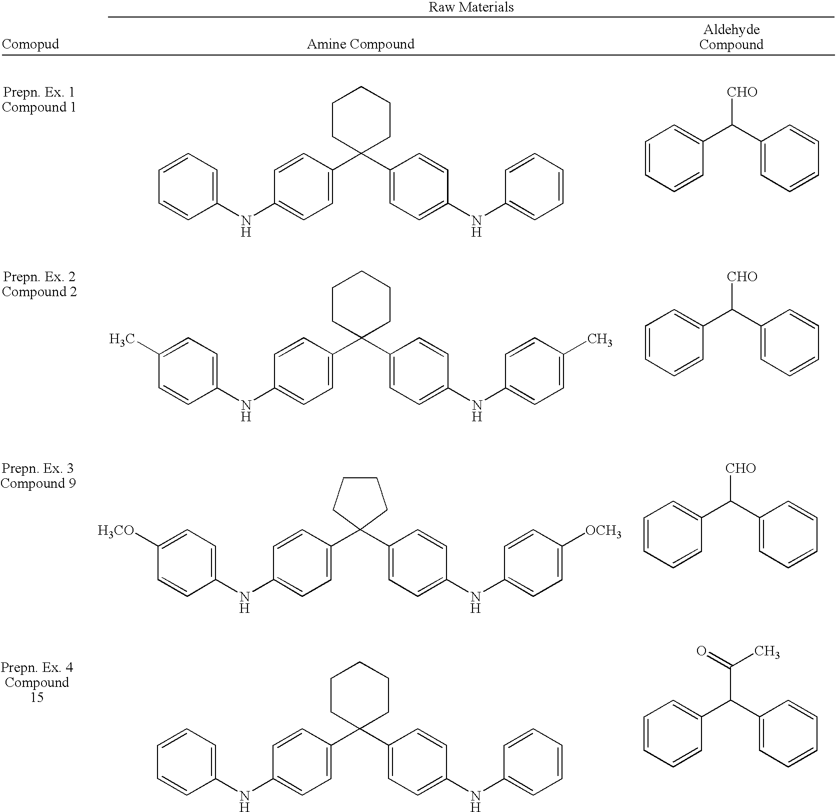

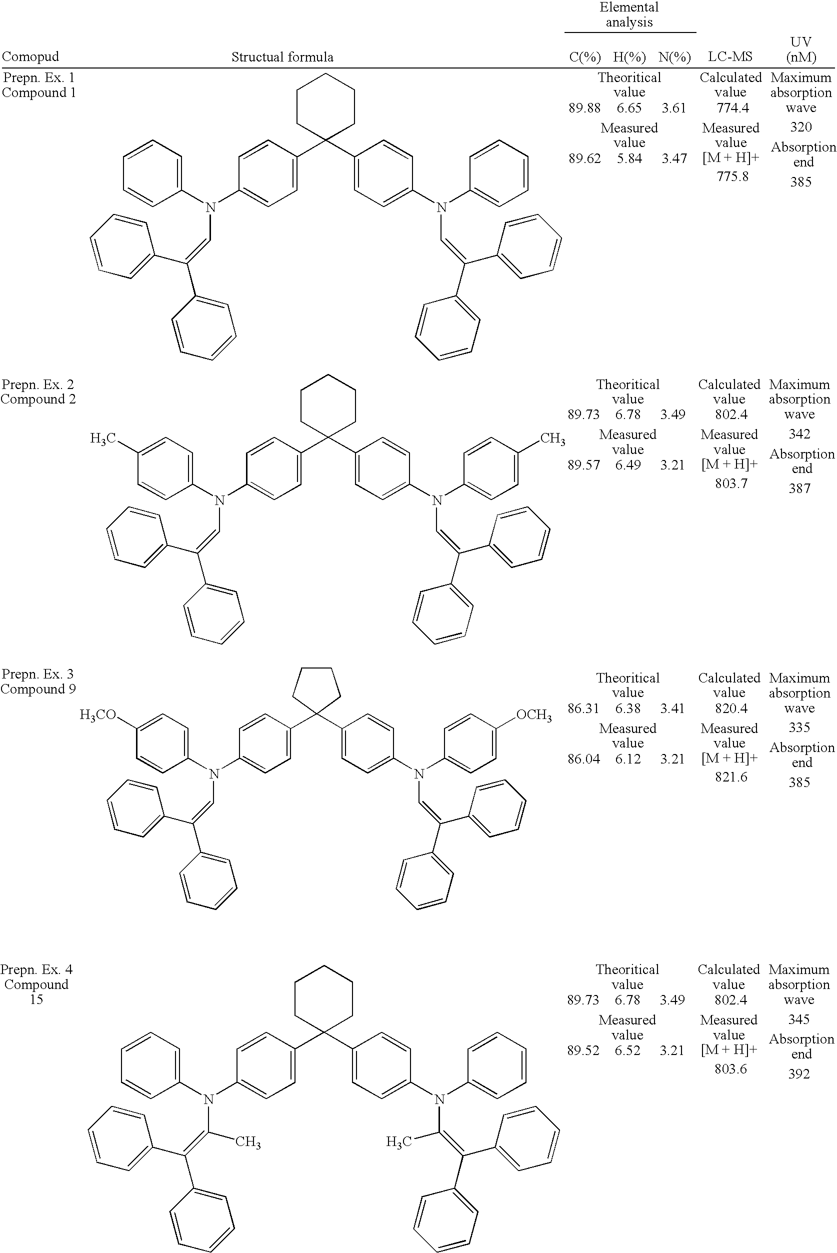

### Example 1

A photoreceptor was prepared, that has a charge transport layer comprising Compound 1 prepared in Preparation Example 1; Compound 1 is the enamine compound of the present invention.

As a conductive substrate, a polyethylene terephthalate (abbreviated to PET) film with a thickness of 100 μm is used, that was vapor-deposited with aluminum on its surface. (The above-mentioned film will be hereinafter referred to as “aluminum vapor-deposited PET film”.)

7 parts by weight of titanium oxide (trade name: Tipaque TTO55A; manufactured by Ishihara Sangyo Kaisha, Ltd.) and 13 parts by weight of a copolymerized nylon resin (trade name: Amilan CM8000; manufactured by Toray Industries, Inc.) were added to a mixed solvent of 159 parts by weight of methyl alcohol and 106 parts by weight of 1,3-dioxolan, and a mixture was subjected to a dispersion treatment for eight hours with use of a paint shaker in order to prepare 100 g of a coating solution for preparing an under-coating layer. This coating solution was applied, with use of an applicator, to the aluminum surface of the aluminum vapor-deposited PET film, which is the conductive substrate, and was dried naturally in order to form an under-coating layer with a thickness of 1 μm.

Subsequently, 2 parts by weight of an azo compound represented by the following structural formula (6):

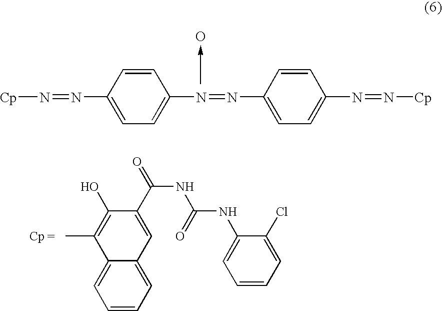

and 1 part by weight of a butyral resin (trade name: #6000-C; manufactured by Denki Kagaku Kogyo Kabushiki Kaisha) were mixed with 98 parts by weight of methyl ethyl ketone, and a mixture was subjected to a dispersion treatment with use of a paint shaker in order to prepare 50 g of a coating solution for preparing a charge generation layer. This coating solution was applied to a surface of the under-coating layer, which was previously applied to the aluminum vapor-deposited PET film, in the same manner as the under-coating layer; and was dried naturally in order to form a charge generation layer with a thickness of 0.4 μm.

Further, 10 parts by weight of the enamine compound of Compound 1, 18 parts by weight of a polycarbonate resin (trade name: Z200; manufactured by Mitsubishi Gas Chemical Co., Inc.), and 0.2 parts by weight of 2,6-di-t-butyl-4-methylphenol were dissolved in 140 parts by weight of tetrahydrofuran. This coating solution was applied to a surface of the charge generation layer with use of a Baker applicator, and was dried in order to form a charge transport layer with a thickness of 20 μm. Accordingly, a laminated electrophotographic photoreceptor was prepared, that has the laminated structure shown in FIG. 1.

### Examples 2 to 4

Electrophotographic photoreceptors were prepared in the same manner as Example 1 except that Compounds 2, 9 and 16 shown in Tables 1-1, 1-2 and 1-4, which are the examples of the enamine compound, were respectively used instead of Compound 1.

### Example 5

An electrophotographic photoreceptor having the laminated structure shown in FIG. 1 was prepared in the same manner as Example 1 except that an under-coating layer was not provided to the photoreceptor.

### Examples 6 to 8

Electrophotographic photoreceptors were prepared in the same manner as Example 5 except that Compounds 2, 9 and 16 shown in Tables 1-1, 1-2 and 1-4, which are the examples of the enamine compound, were respectively used instead of Compound 1.

### Comparative Example 1

An electrophotographic photoreceptor was prepared in the same manner as Example 1 except that, instead of Compound 1, a comparative compound represented by the following structural formula (7) was used:

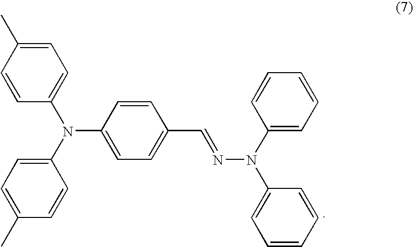

### Comparative Example 2

An electrophotographic photoreceptor was prepared in the same manner as Example 1 except that, instead of Compound 1, a comparative compound represented by the following structural formula (8) was used:

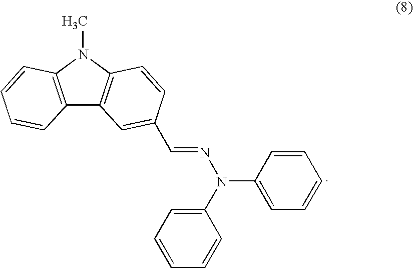

### Comparative Example 3

An electrophotographic photoreceptor was prepared in the same manner as Example 1 except that, instead of Compound 1, a comparative compound represented by the following structural formula (9) was used:

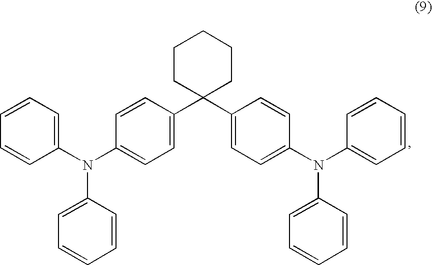

### Example 9

Coating solutions for applicable layers were prepared in the same manner as Example 1, and the coating solutions were applied to an aluminum vapor-deposited PET film so that the laminated electrophotographic photoreceptor shown in FIG. 2 was prepared, in which the charge generation layer and the charge transport layer are laminated opposite to the lamination order shown in FIG. 1.

### Example 10

A coating solution for preparing an under-coating layer was prepared in the same manner as Example 1, applied to an aluminum vapor-deposited PET film, and dried in order to form an under-coating layer with a thickness of 1 μm.

Subsequently, a coating solution for preparing a photosensitive layer was prepared by dispersing the below-mentioned components for twelve hours, applied to a surface of an under-coating layer with use of a Baker applicator, and dried for one hour with use of hot air at 110° C. in order to form a photosensitive layer with a thickness of 20 μm. Accordingly, a single-layer electrophotographic photoreceptor was prepared, that has the structure shown in FIG. 3.

### Coating Solution of the Photosensitive Layer

| | | |
|---|---|---|
| Azo Compound Represented by the | 1 | part by weight |
| Above-Mentioned Structural Formula (6) | | |
| Polycarbonate Resin | 14 | parts by weight of |
| | | Z-400 manufactured |
| | | by Mitsubishi Gas |
| | | Chemical Co., Inc. |
| Compound | 10 | parts by weight |
| 3-Bromo-5,7-Dinitrofluorenone | 5 | parts by weight |
| 2,6-Di-t-Butyl-4-Methyphenol | 0.5 | parts by weight |
| Tetrahydrofuran | 150 | parts by weight |

The electrophotographic photoreceptors, which were prepared as described above, were evaluated under the below-mentioned condition(s) with use of an electrostatic paper analyzer (trade name: EPA-8200; manufactured by Kawaguchi Electric Works Co., Ltd.).

### Surface Potential of the Photoreceptors Each

−600V

### Wavelength of Light (Separated by a Monochromator)

450 nm

An evaluation sensitivity (i.e. E decreases by half (E_{1/2})) was calculated from light intensity at the time of indicating −300V of a surface potential of each monochromatic wavelength.

Also, a residual surface potential (Vr) was measured thirty seconds after the exposure.

Each of electrical charge differences (ΔV₀, ΔV₁) was calculated from initial sensitivity of a dark-section electric potential (V₀ which was initially set at 600V) and a bright-section electric potential (V₁ which was initially set at 100V) each after electrification, exposure and neutralization were repeated one thousands times with use of monochromatic light with a wavelength of 450 nm.

A negative sign and a positive sign respectively indicate a decrease and an increase in absolute value of an electric potential through potential variations. Incidentally, an electric polarity of Examples 5 and 6 each was set to be positive.

Results thereby obtained are shown in Table 3 below.

TABLE 3

| | | Charge | Charge | Initial property | | Repetition | |
|---|---|---|---|---|---|---|---|
| | | generation | transport | E_{1/2} | | property | |
| | Undercoat layer | material | material | (mJ/cm²) | Vᵣ (V) | ΔV₀ (V) | ΔV₁ (V) |
| Ex. 1 | present | azo compd. | compd. 1 | 0.55 | −22 | −18 | 17 |
| Ex. 2 | present | azo compd. | compd. 2 | 0.48 | −25 | −22 | 13 |
| Ex. 3 | present | azo compd. | compd. 9 | 0.4 | −20 | −28 | 20 |
| Ex. 4 | present | azo compd. | compd. 15 | 0.56 | −31 | −21 | 17 |
| Ex. 5 | absent | azo compd. | compd. 1 | 0.54 | −20 | −25 | 12 |
| Ex. 6 | absent | azo compd. | compd. 2 | 0.47 | −24 | −30 | 7 |
| Ex. 7 | absent | azo compd. | compd. 9 | 0.41 | −21 | −36 | 15 |
| Ex. 8 | absent | azo compd. | compd. 15 | 0.54 | −27 | −27 | 12 |
| Ex. 9 | present | azo compd. | compd. 1 | 0.48 | 21 | −19 | 23 |
| Ex. 10 | present | azo compd. | compd. 1 | 0.4 | 24 | −41 | 21 |
| Comp. Ex. 1 | present | azo compd. | comp. compd. | 3.25 | −265 | −85 | 85 |
| | | | (7) | | | | |
| Comp. Ex. 2 | present | azo compd. | comp. compd. | 3.75 | −325 | −65 | 98 |
| | | | (8) | | | | |
| Comp. Ex. 3 | present | azo compd. | comp. compd. | 3.61 | −215 | −75 | 78 |
| | | | (9) | | | | |

It was found from the above-mentioned results that the electrophotographic photoreceptor of the present invention was superior in sensitivity in the short-wavelength area to and more stable in repetition property than that of Comparative Examples each.

It was also found that the electrophotographic photoreceptor without the under-coating layer showed a slight tendency to improve ΔV₁ but to worsen ΔV₀ after the electrification, exposure and neutralization were repeated one thousands times.

### Example 11

An electrophotographic photoreceptor was prepared in the same manner as Example 1 except that, as a charge generation substance, a thioindigo compound represented by the following structural formula (10) was used:

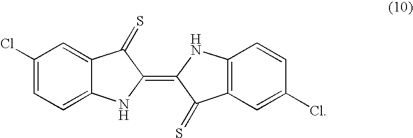

### Examples 12 to 14

Electrophotographic photoreceptors were prepared in the same manner as Example 11 except that Compounds 2, 9 and 16 shown in Tables 1-1, 1-2 and 1-4, which are the examples of the enamine compound, were respectively used instead of Compound 1.

### Comparative Example 4

An electrophotographic photoreceptor was prepared in the same manner as Example 11 except that Comparative Compound (9) was used instead of Compound 1.

The electrophotographic photoreceptors of Examples 11 to 14 and Comparative Example 4 were evaluated in the same manner as Examples 1 to 10 and Comparative Examples 1 to 3 except that these electrophotographic photoreceptors each were exposed to laser beams with wavelengths of 400 nm, 500 nm and 600 nm. Results thereby obtained are shown in Table 4 below.

TABLE 4

| | Charge | Charge | Initial property | | | Repetition | |
|---|---|---|---|---|---|---|---|
| | generation | transport | E_{1/2} (mJ/cm²) | | | property | |
| | material | material | 400 nm | 500 nm | 600 nm | ΔV₀ (V) | ΔV₁ (V) |
| Ex. 11 | Thioindigo | Compd. 1 | 1.02 | 1.08 | 1.26 | −20 | 20 |
| | compd. | | | | | | |
| Ex. 12 | Thioindigo | Compd. 2 | 0.98 | 1.02 | 1.24 | −22 | 21 |
| | compd. | | | | | | |
| Ex. 13 | Thioindigo | Compd. 9 | 0.94 | 1.05 | 1.27 | −24 | 25 |
| | compd. | | | | | | |
| Ex. 14 | Thioindigo | Compd. 16 | 1.08 | 0.12 | 1.4 | −16 | 18 |
| | compd. | | | | | | |
| Comp. Ex. 4 | Thioindigo | Comp. compd. | 3.08 | 3.1 | 3.21 | −90 | 115 |
| | compd. | (9) | | | | | |

It was found from the above-mentioned results that the electrophotographic photoreceptor of the present invention was superior in sensitivity in the short-wavelength area to and more stable in repetition property than that of Comparative Example.

### Example 15

The coating solution for preparing the under-coating layer used in Example 1 was applied, with use of an immersion-coating applicator, to a surface of an aluminum drum-like substrate with a thickness of 0.8 mm (t), a diameter of 30 mm (Φ), and a length of 326.3 mm, and dried in order to form an under-coating layer with a thickness of 1.0 mm.

Subsequently, the coating solution for preparing the charge generation layer used in Example 1 was applied to the aluminum drum-like substrate, to which the under-coating layer was applied, in order to form a charge generation layer with a thickness of 0.5 mm.

Further, a coating solution for preparing a charge transport layer was prepared in the same manner as Example 1, applied to the aluminum drum-like substrate, and dried for one hour at 110° C. in order to form a charge transport layer with a thickness of 20 mm.

This electrophotographic photoreceptor was installed in a copy machine remodeled from a Sharp copy machine AR-F330 (in which a semiconductor laser that emits a laser beam with an oscillation wavelength of 405 nm was installed as a light source). The copy machine installed with the above-mentioned electrophotographic photoreceptor was to output an image having 1 dot in 1 space with resolution of 1200 dpi and a letter image having 5 points, and image evaluations were conducted.

### Comparative Example 5

An electrophotographic photoreceptor was prepared in the same manner as Example 11 except that the charge transport substance (9) used in Comparative Example 3 was used instead of the charge transport substance used in Example 11. Image evaluations were conducted in the same manner as Example 15. Results thereby obtained in Example 15 and Comparative Example 5 are shown in Table 5 below.

TABLE 5

| | Charge transport | Repeatability | Repeatability of |
|---|---|---|---|
| | material | of dot | letter |
| Ex. 15 | Compd. 1 | ◯ | ◯ |
| Comp. Ex. 5 | Comp. Compd. (9) | X | X |

Repeatability of dot; ◯: Clear image X: Unclear image caused by disarrayed dots
Repeatability of letter; ◯: Clear image X; Unclear letter

It was found from the above-mentioned results that the electrophotographic photoreceptor and the image forming apparatus of the present invention were exceedingly excellent in repeatability of the dot and letter, and can output an image with high resolution.

### Example 16

An electrophotographic photoreceptor was prepared in the same manner as Example 11. This electrophotographic photoreceptor was installed in the copy machine of Example 15, and then image evaluations were conducted after 100,000 sheets were printed out.

### Comparative Example 6

An electrophotographic photoreceptor was prepared in the same manner as Comparative Example 5. This electrophotographic photoreceptor was installed in the copy machine of Example 1 5, and then image evaluations were conducted after 100,000 sheets were printed out. Results thereby obtained in Example 16 and Comparative Example 6 are shown in Table 6 below.

TABLE 6

| | Charge transport | Repeatability | Repeatability of |
|---|---|---|---|
| | material | of dot | letter |
| Ex. 16 | Compd. 1 | ◯ | ◯ |
| Comp. Compd. 6 | Comp. Compd. (9) | X | X |

Repeatability of dot; ◯: Clear image X: Unclear image caused by disarrayed dots
Repeatability of letter; ◯: Clear image X; Unclear letter

It was found from the above-mentioned results that the electrophotographic photoreceptor and the image forming apparatus of the present invention were excellent in durability, and can output an image with high resolution.

Consequently, the present invention can provide the electrophotographic photoreceptor having the high sensitivity and resolving power and the electrophotographic apparatus provided therewith, since the electrophotographic photoreceptor comprises the enamine compound represented by the above-mentioned general formula (1) that absorbs the laser beam in the wavelength area of from 390 nm to 500 nm inclusive emitted from the light source.

What is claimed is:

1. An electrophotographic photoreceptor that is exposed to a laser beam with oscillation wavelengths of from 390 nm to 500 nm inclusive which is oscillated from a semiconductor laser, and that is provided with a photosensitive layer formed on a conductive substrate, the photosensitive layer comprising an enamine compound represented by the following general formula (1): 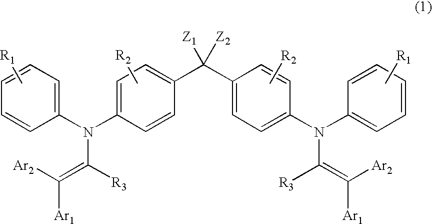
wherein Ar₁ and Ar₂ are independent from each other, and each represent an aryl or heterocyclic group which may have a substituent(s);
R₁ and R₂ are independent from each other, and each represent a hydrogen atom, a halogen atom or an alkyl or alkoxy group which may have a substituent(s);
R₃ represents a hydrogen atom or an alkyl group which may have a substituent(s); and
Z₁ and Z₂ are independent from each other, and each represent an alkyl group, or may be combined together with the carbon atom with which these groups are connected to form a ring structure.

2. The electrophotographic photoreceptor according to claim 1, comprising the enamine compound represented by the general formula (1),
wherein Ar₁ and Ar₂ are independent from each other, and each represent a phenyl, naphthyl, furyl or thienyl group which may have a substituent(s);
R₁ and R₂ each represent a hydrogen atom, a halogen atom or a methyl, ethyl, methoxy, ethoxy or trifluoromethyl group;
R₃ represents a hydrogen atom or a methyl or ethyl group; and
Z₁ and Z₂ are independent from each other, and each represent a methyl, ethyl or n-propyl group or a cyclopentylene, cyclohexylene or cycloheptylene group which is a ring structure formed together with the carbon atom with which Z₁ and Z₂ are connected.

3. The electrophotographic photoreceptor according to claim 1, comprising the enamine compound represented by the general formula (1),
wherein Ar₁ and Ar₂ are independent from each other, and each represent a methyl or ethyl group or a phenyl, naphthyl, furyl or thienyl group which may have a methoxy group;
R₁ and R₂ each represent a hydrogen atom, a chlorine atom or a methyl, ethyl, methoxy, ethoxy or trifluoromethyl group;
R₃ represents a hydrogen atom or a methyl group; and
Z₁ and Z₂ are independent from each other, and each represent a methyl group or a cyclopentylene, cyclohexylene or cycloheptylene group which is a ring structure formed together with the carbon atom with which Z₁ and Z₂ are connected.

4. The electrophotographic photoreceptor according to any one of claim 1, wherein the photosensitive layer has a laminated structure constituted of a charge generation layer and a charge transport layer; the charge generation layer comprises at least a charge generation substance, and the charge transport layer comprises at least a charge transport substance; and the charge transport substance is the enamine compound.

5. The electrophotographic photoreceptor according to claim 4, wherein the photosensitive layer is laminated on the conductive substrate and is constituted of the charge generation layer and the charge transport layer.

6. The electrophotographic photoreceptor according to claim 4, wherein the charge transport layer comprises the charge transport substance having a quantitative ratio to a binder ranging from 10/12 to 10/25 inclusive.

7. The electrophotographic photoreceptor according to any one of claim 1, wherein the photoreceptor has an under-coating layer between the conductive substrate and the photosensitive layer.

8. The electrophotographic photoreceptor according to claim 7, wherein the under-coating layer has thicknesses ranging from 0.01 μm to 10 μm inclusive.

9. An image forming apparatus that is provided with the electrophotographic photoreceptor according to claim 1 and as an exposing source, a semiconductor laser emitting a laser beam with oscillation wavelength of from 390 nm to 500 nm inclusive.

10. The image forming apparatus according to claim 9 that forms an image by a reversal development process.
